(19) United States
(12) Patent Application Publication
(10) Pub. No.: US 2025/0244495 A1
(43) Pub. Date: Jul. 31, 2025

(54) AUTONOMOUS MONITORING OF FLUID IN SUBTERRANEAN SYSTEMS

(71) Applicant: Baker Hughes Oilfield Operations LLC, Houston, TX (US)

(72) Inventors: Valeria Di Filippo Chann, Normal, IL (US); Pierre Gouedard, Sainte Tulle (FR); Pramit Basu, Spring, TX (US); Jean-Michel Embry, Pierrevert (FR); Ole Engels, Houston, TX (US); Svein Hovland, Spring, TX (US); David Katz, Spring, TX (US); Namsu Park, Houston, TX (US); Sergey Kotov, Spring, TX (US)

(21) Appl. No.: 19/039,320

(22) Filed: Jan. 28, 2025

Related U.S. Application Data
(60) Provisional application No. 63/626,224, filed on Jan. 29, 2024.

(51) Int. Cl. G01V 1/30; E21B 41/00; G01V 1/28

(52) U.S. Cl. CPC G01V 1/306; E21B 41/0064; G01V 1/288

(57) ABSTRACT

A system for monitoring a subterranean region includes a surface assembly including a processor and a communication device, and a plurality of measurement stations distributed about the subterranean region and configured to autonomously measure an evolution of a fluid injected into the subterranean region. Each measurement station includes a first measurement device configured to measure a first property and a second measurement device configured to measure a second property that is different than the first property. The processor is configured to receive measurement data from each measurement stations, and determine a location and a concentration of at least a portion of the injected fluid.

### CROSS-REFERENCE TO RELATED APPLICATION

This application claims the benefit of an earlier filing date from U.S. Provisional Application Ser. No. 63/626,224 filed Jan. 29, 2024, the entire disclosure of which is incorporated herein by reference.

### BACKGROUND

Some forms of energy production involve a number of diverse activities from various engineering fields to be performed in a borehole penetrating a subterranean region. For example, various drilling, exploration, stimulation and production processes are performed in the context of producing hydrocarbons. Other activities include carbon sequestration and geothermal energy recovery.

In applications such as stimulation, production and carbon sequestration, monitoring the presence and evolution of fluids, such as hydrocarbons and carbon dioxide gas, is important. For example, in carbon sequestration operations, seismic surveys are typically used to monitor the extent and movement of CO2 gas within a formation.

### SUMMARY

An embodiment of a system for monitoring a subterranean region includes a surface assembly including a processor and a communication device, and a plurality of measurement stations distributed about the subterranean region and configured to autonomously measure an evolution of a fluid injected into the subterranean region. Each measurement station includes a first measurement device configured to measure a first property and a second measurement device configured to measure a second property that is different than the first property. The processor is configured to receive measurement data from each measurement stations, and determine a location and a concentration of at least a portion of the injected fluid.

An embodiment of a method of monitoring a subterranean region includes receiving, by a surface assembly, measurement data from a plurality of remotely located measurement stations distributed about the subterranean region, each measurement station configured to autonomously measure properties of a fluid injected into the subterranean region, each measurement station including a first measurement device configured to measure a first property and a second measurement device configured to measure a second property that is different than the first property. The method also includes determining a location and a concentration of at least a portion of the injected fluid based on the measurement data.

### BRIEF DESCRIPTION OF THE DRAWINGS

The following descriptions should not be considered limiting in any way. With reference to the accompanying drawings, like elements are numbered alike:

FIG. 1 depicts an embodiment of an injection system and a distributed monitoring system for monitoring a subterranean region;

FIG. 2 depicts an embodiment of a measurement station of a distributed monitoring system;

FIG. 3 depicts an example of a model of a distribution of an injected fluid in a subterranean region;

FIG. 4 depicts examples of locations of localized measurements (targeted measurements) based on a model of a distribution of an injected fluid in a subterranean region;

FIG. 5 is a heat map showing an example of changes in a subterranean gas plume;

FIG. 6 is a graph that shows examples of groundwater quality monitoring data generated by an autonomous measurement station;

FIG. 7 is a flow diagram that shows aspects of a method of monitoring a subterranean region;

FIG. 8 depicts the model of FIG. 2 updated based on measurements performed using a distributed monitoring system; and

FIG. 9 shows an example of locations selected for performing targeted measurements based on the updated model of FIG. 8.

### DETAILED DESCRIPTION

Systems and methods are described herein that provide for monitoring a subterranean region. An embodiment of a monitoring system includes a plurality of autonomous measurement stations distributed about an injection zone of the subterranean region (i.e., distributed as surface locations above the injection zone and/or the subterranean region. Each measurement station includes a plurality of different sensors or devices for detecting different properties related to fluid injected into, or otherwise disposed in, the injection zone. Each measurement station includes a processor that can autonomously (i.e., without direct control by a remote device or system) control operation of sensors in the measurement station. The measurement stations may also have individual power sources, such as batteries and/or solar panels. Each measurement station, in an embodiment, is configured to communicate (wirelessly or wired) with a centralized processor.

In an embodiment, the monitoring system is configured to monitor the location and movement of carbon dioxide in the injection zone, in conjunction with a carbon sequestration operation. A volume or amount of a liquid or gas in the injection zone is referred to as a “plume.” For example, each monitoring station includes a seismic sensor, and at least one additional sensor, such as an atmospheric sensor, near surface sensor, soil gas sensor, groundwater sensor and/or other sensor(s) relevant to monitoring subterranean fluids. Although embodiments are described in conjunction with carbon sequestration, embodiments are not so limited and may be used to monitor any fluid in a subterranean region or formation.

Embodiments described herein present a number of advantages. The monitoring system described herein provides for improvements in sequestered carbon dioxide monitoring (or other fluid or gas monitoring). Such improvements include, for example, the ability to autonomously monitor subterranean regions with improved accuracy and a higher temporal resolution as compared to existing systems.

For example, embodiments improve fluid mapping using plume expansion maps and/or high-fidelity targeted measurements (and other information, such as caprock integrity and fault stability data) on a real time basis or a periodic basis. This form of monitoring reduces the need to routinely acquire time-lapse three-dimensional (3D) seismic survey data, dramatically reducing the total operating costs while de-risking over the life of a project. In addition, the measurement stations may have spare capacity to monitor the surface and shallow subsurface (e.g., soil, aquifer, and atmospheric regions), satisfying regulatory requirements and providing assurance to landowners and stakeholders.

In addition, the monitoring system can be used in a variety of onshore and offshore environments, and is flexible, allowing for use of a variety of sensors to monitor parameters of interest, making the system fully customizable while utilizing the same infrastructure.

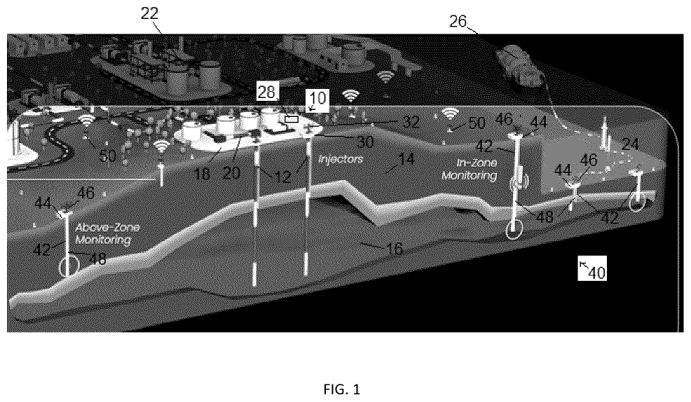

FIG. 1 depicts an embodiment of a downhole system 10 configured for storage or sequestration of carbon dioxide gas or other fluid. It is noted that embodiments described herein are not limited to fluid storage or sequestration applications, and may be used in conjunction with various downhole and/or energy production operations. Examples of such operations include drilling, stimulation, exploration, production and any other operation for which subsurface fluid monitoring is desired.

In an embodiment, the system 10 includes one or more injector wells 12 (also referred to as injectors 12) that extend into a subterranean region 14. The injectors 12 are configured to inject carbon dioxide (CO2) and store CO2 gas in a formation or other area within the subterranean region 14. This area is referred to as an injection zone 16, which may be any subterranean area or formation capable of fluid storage. For example, the injection zone is a porous and permeable region that is below a non-permeable layer (caprock).

The injectors 12 are connected to surface equipment 18. The surface equipment 18 includes various devices or systems for facilitating injection and process control. The surface equipment 18 may include tanks and/or pipes for storing and/or transmitting a fluid, such as flue gas, combustion products, captured CO2 and/or any other suitable fluid. For example, the surface equipment 18 includes pipes or conduits 20 that transfer CO2 fluid or gas from a CO2 capture system 22.

The system 10 may be an onshore and/or offshore system. For example, the system 10 may include offshore surface equipment 24 (e.g., subsea wellhead, umbilical, etc.) that includes a buoy and/or an offshore vessel 26. For example, a measurement station may be incorporated into, or connected to, an offshore floating device or other offshore equipment.

The system 10 includes components for communication with various entities, such as a data center, database, workstation and/or control center. In addition, the system 10 includes components for communicating with measurement stations 42 of a distributed monitoring system 40 described further herein.

For example, the surface equipment 18 includes a surface processing unit 28 that may be configured to control aspects of a sequestration operation, such as pump pressure, flow rate and others. The surface processing unit 28, in an embodiment, includes a wireless communication device 30 having components such as a communication module and an antenna 32 for receiving measurement data from components of a monitoring system 40.

In an embodiment, the monitoring system 40 is a distributed monitoring system that includes a plurality of individual monitoring stations 42. Each monitoring station may be controlled by a remote entity (e.g., the surface processing unit 28) or by a local processor. In an embodiment, each monitoring unit 42 is autonomous, including a local processing device that controls aspects of sensor operation, data collection, and transmission.

The monitoring system 40 integrates a variety of remote field measurements to enhance understanding of fluid movements, such as a subterranean CO2 plume. The remote field measurements are received from one or more of the autonomous measurement stations 42 (e.g., all of the stations 42 or a group of the stations 42). In an embodiment, the remote field measurements are transmitted to a central processor for analysis. The central processor may be the surface processing unit 28 or other device or system.

By combining seismic surveys with additional information from real time measurements (e.g., plume mapping, targeted measurements and/or shallow subsurface monitoring), a CO2 plume can be effectively tracked. Such real time measurements allow, for example, to track plume changes between seismic surveys.

For example, the monitoring system 40 includes a plurality of measurement stations 42 disposed at various locations in and around the injection zone 16. Each measurement station 42 includes a surface assembly 44 that includes a processor or processing system (not shown) and a wireless communication device 46. Each measurement station 42 also includes a set of sensors disposed at one or more of various locations along a sensor string 48 that extends into a shallow borehole. A “shallow” borehole is a borehole that extends into the subterranean region 14 to a location that is within, above or near the injection zone 16.

Measurement data from each measurement station 42 is transmitted (e.g., in real time) to the surface processing unit 28 or other analysis system that processes and/or analyzes the received data.

Data from the measurement stations 42 may be combined with any other suitable information and data. For example, a three-dimensional (3D) seismic survey system includes a plurality of seismic detectors 50 arrayed along a surface above the injection zone. The seismic detectors 50 are used to detect seismic waves in response to an active seismic source. Active 3D seismic data may be combined with measurements from the measurement stations 42 for monitoring plumes and formation integrity.

For example, active 3D seismic surveys are performed periodically (e.g., yearly or every three years) and used to generate or update a model of a CO2 plume. Between surveys, the distributed monitoring system 40 is used periodically or in real time to monitor the plume, update the model and/or identify potential threats to the integrity of the injection zone 16.

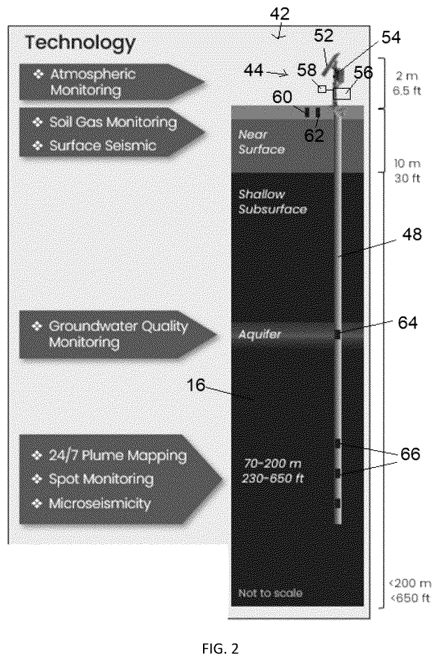

FIG. 2 depicts an embodiment of a measurement station 42 in an onshore context. The surface assembly 44 includes equipment for data collection, sensor control and/or communication. For example, a cabinet or other structure houses components that include a power system 52, such as a solar power system, and a wireless communication module 54. Other components may include a GPS receiver and a battery charged by the power system 52. A processing device 56 includes a digitizer that integrates all the data from the sensor or sensors that are linked to it.

In an embodiment, the measurement station 42 constitutes an all-in-one fully autonomous monitoring system. In other words, the measurement station 42 is a single integrated device that performs tasks ranging from the recording of data, digitization, and transmittal a central processor and/or other entity (e.g., a client and/or service provider), in real time or on demand.

Each measurement station 42 includes sensors configured for measuring one or more parameters of the injection zone 16, such as a seismic sensor, and may include additional sensors for measuring parameters related to the injection zone, equipment and/or other parameters relevant to an operation. Such additional sensors may include one or more sensors for measuring parameters related to device or equipment integrity and/or environmental conditions.

For example, the measurement station 42 includes an atmospheric monitoring sensor 58 (e.g., a CO2 sensor) deployed at or above the surface (e.g., for measuring CO2 concentration in ambient air), and near surface sensors such as a soil gas monitoring sensor 60 and/or a surface seismic sensor 62. The soil gas monitoring sensor 60 may be used to measure concentrations and/or ratios of gases in the shallow subsurface. A groundwater quality sensor 64 may be included in a subsurface region having an aquifer or other presence of water. For example, the groundwater quality sensor 64 is configured to measure water electrical conductivity (WEC) and/or pH.

Additional sensors 66 (referred to as “in-zone” sensors) may be deployed below the aquifer level for measuring parameters related to plume mapping, targeted monitoring and microseismicity. It is noted that the measurement station 42 may have any number of sensors at any of a variety of locations, and is thus not limited to any specific configuration discussed herein.

The monitoring system 40 is configured to perform a monitoring method that includes collecting real time (or periodic) measurement data from each measurement station 42 (or a subset of the measurement stations 42), and analyzing the measurement data to monitor parameters of subterranean fluid.

Microseismic monitoring may be used to measure seismic activity and noise in the subsurface. Microseismic monitoring is typically passive, in that seismic activity is monitored without an active seismic source.

Monitoring seismicity is useful, for example, in maintaining formation and caprock integrity in Carbon Capture & Storage (CCS) applications. In terms of physical integrity, seismicity in the caprock can be an indicator of the risk of catastrophic failure. At the reservoir scale, seismicity at faults can show that they are being reactivated by fluid injection or that they could provide a pathway to the surface for the stored fluids.

With more and more public attention towards induced seismicity many regulatory bodies across the world often require microseismic monitoring as a mean to minimize potential induced seismicity and potential migration risks.

In an embodiment, ambient noise monitoring is used for plume mapping, in which the extent, concentration variance profile and/or movement of a CO2 or gas plume is estimated For example, ambient noise is passively monitored using a microseismic sensor, and is used to provide an early warning or indication that a plume may be out of conformance. The warning or indication may prompt further assessment, such as performing a 3D seismic survey. In this way, an operator or system can be alerted to address a potential nonconformance, which would otherwise go undetected (e.g., at least until a next scheduled).

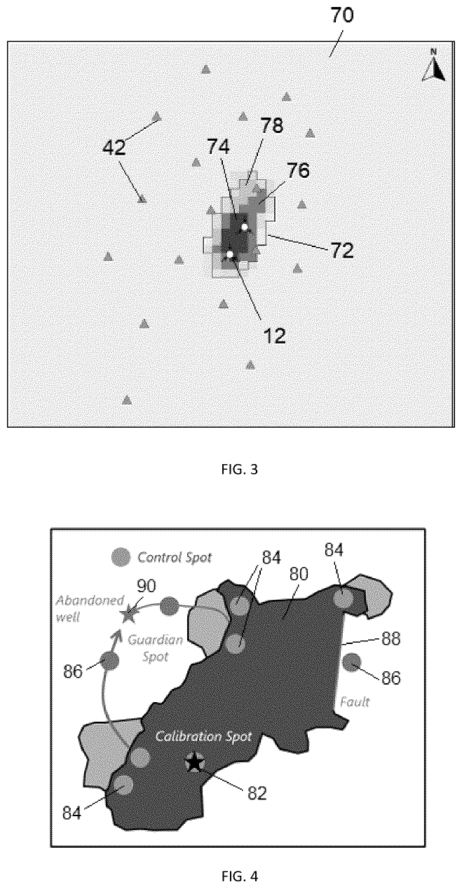

FIG. 3 depicts an example of a plume map 70, which shows a CO2 plume detected using passive seismic and/or ambient noise data collected from the measurement stations 42. Seismic anthropogenic noise is recorded using microseismic sensors (e.g., subsurface sensors 66) and processed to extract a wavefield that has been propagating within the subsurface, hence probing its properties. Such seismic reconstruction can be achieved quasi-continuously, using quick and cost-effective processing routines, allowing for constant monitoring of the subsurface through body and surface wave analysis.

The plume map 70 shows the surface location of various measurement stations 42 and the injectors 12, and a location and extent of a CO2 plume. The plume map 70 is a two-dimensional array of cells or pixels, where each cell or pixel is color coded or shaded to indicate a CO2 concentration variance. In this example, the plume is represented by a group of cells 74 having a high concentration variance, a group of cells 76 having an intermediate concentration variance and cells 78 having a low concentration variance. Based on this concentration variance profile, a model of the plume is generated, represented by a boundary 72.

The terms “high”, “intermediate” and “low” are relative terms, and are not intended to denote any specific concentration value or range.

A single measurement station 42 (or a subset of the measurement stations 42) may be used to generate a target measurement, which is a localized measurement of seismic activity. Targeted measurements are used, for example, to detect local changes in a region of the injection zone 16 that correspond to a location where the injected fluid is expected or not expected to be at a point in time.

Targeted measurements may be used in conjunction with plume mapping, for example, to adjust, validate or invalidate a model of a plume. For example, targeted measurements are performed at desired locations to validate and/or update the model.

FIG. 4 shows an example of the use of targeted measurements to validate and/or adjust a model. In this example, a two-dimensional model 80 of a CO2 plume is shown. Targeted measurements are performed at various locations based on the size and extent of the plume. A calibration location 82 is a measurement performed using a measurement station 42 at a targeted location within the model 80. Other targeted measurements (location 84) may be performed at or near the boundary or edge of the model 80, to determine whether the plume has expanded. Other targeted measurements (“guardian” locations 86) may be performed at locations where plume spread is undesirable. For example, targeted measurements may be performed near a fault 88 and/or other location where CO2 spread should be prevented, such as a location of an abandoned well 90.

The timing and location of targeted measurements may be selected based on any suitable factors. As discussed above, targeted measurements may be performed based on a model of a plume at a given time, may be updated or changed based on the evolution of the plume.

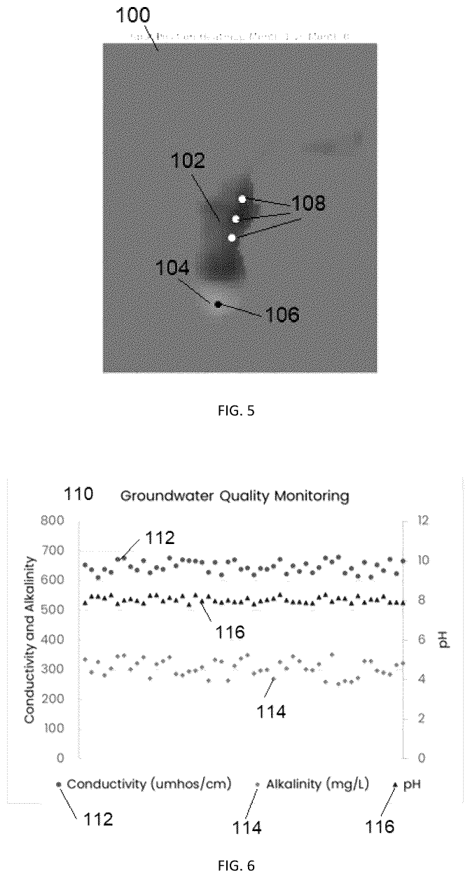

FIG. 5 depicts a heat map 100 that shows changes in a plume over time. The heat map 100 is color coded or shaded based on a change in concentration between a first time (e.g., a month n) and a second time (e.g., a month n+1). In this example, a region 102 represents an increase in the concentration variance, and a region 104 represents a decrease in the concentration variance.

Based on the changes, targeted measurements are performed to monitor the movement and change in the plume. A control location 106 represents a location where a targeted measurement was previously selected. Locations 108 represent locations where targeted measurements are desired to be performed to effectively monitor the plume and follow its progress.

The use of targeted measurements provides for a number of advantages. Targeted measurements as described herein provide a cost-effective solution with low initial investment, and can achieve resolution compatible with project requirements. In addition, targeted measurements enable more frequent focused monitoring with outstanding repeatability, and are well-suited for long-term monitoring. Use of targeted measurements can also significantly reduce environmental impact, such as air-gun/noise emissions associated with active seismic surveys.

As noted above, in addition to seismic data, other types of measurements may be utilized to further analyze plume containment. For example, changes in water salinity could be an indication of influx of brine or carbon dioxide due to a leakage event. Accordingly, groundwater quality monitoring may be used, for example, to satisfy regulators, landowners, or to simply keep a record. In an embodiment, one or more measurement stations 42 include(s) a groundwater quality probe (e.g., the groundwater quality sensor 64 of FIG. 2) suspended at the water table. Groundwater quality measurements include measurements of one or more parameters, such as pH, water electrical conductivity (WEC), temperature, and pressure. Measurements can be done continuously or periodically.

FIG. 6 depicts an example of groundwater monitoring data generated over a selected time window. The data is shown in a graph 110. Conductivity values are shown as data points 112, and alkalinity values are shown as data points 114. pH measurements are shown as data points 116. Samples of groundwater may also be collected, for example, to analyze additional parameters (e.g. total dissolved solids (TDS), major anions and cations, fluid density, etc.).

Atmospheric monitoring capabilities may be incorporated into one or more measurement stations 42. Measuring the concentration of CO2 in the air may be required by some regulatory bodies, and is useful for detection of leaks or contamination stemming from operations. In an embodiment, a measurement station 42 includes a CO2 sensor based on NDIR (Non-Dispersive InfraRed) technology. The sensor is low power and can be integrated seamlessly into the measurement station 42.

Soil monitoring may be used to measure the ratio of gases that exist in the near surface. Natural respiration and seasonal variations can be distinguished from a potential leak by examining relationships between gas concentrations, such as relationships between oxygen and CO2 concentrations. Soil monitoring serves to satisfy regulatory requirements, to identify potential leaks and/or to simply keep a record.

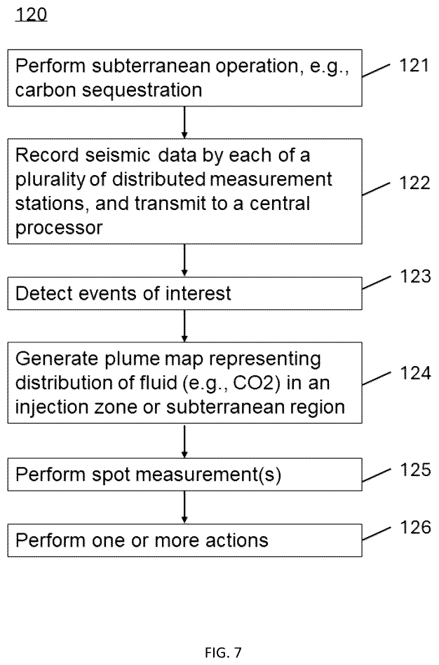

FIG. 7 illustrates embodiments of a method 120 of monitoring a subterranean region and monitoring fluid therein, such as CO2. The method 120 is described in conjunction with the monitoring system 40 and the measurement stations 42 of FIGS. 1 and 2 for illustration purposes, but may be employed with any suitable system. In addition, aspects of the method 120 are described as being performed by the surface processing unit 28 of FIG. 1, but is not so limited and may be performed using any suitable processor or combination of processors.

The method 120 includes a number of steps or stages represented by blocks 121-126. The method 120 is not limited to the number or order of steps therein, as some steps represented by blocks 121-126 may be performed in a different order than that described below, or fewer than all of the steps may be performed.

At block 121, a subterranean operation is performed. In an embodiment, the operation is a carbon sequestration operation, in which gaseous or liquid or supercritical CO2 is injected into the injection zone 16.

At block 122, seismic sensors (e.g., a subsurface sensor 66) in each measurement station 43 records microseismic data and transmits the microseismic data to the surface processing unit 28 or other suitable central processor, processing device or system.

At block 123, microseismic data from each station 42 is analyzed to detect any events of interest. The location and magnitude of each event is estimated. If any critically stressed areas are identified, the surface processing unit 38 may provide an alert or warning.

At block 124, a plume map or other data structure is generated from the microseismic data and/or other data (e.g., periodically performed active seismic surveys). For example, the plume map 70 is generated as discussed above.

At block 125, one or more targeted measurements are performed. The targeted measurements are high-fidelity measurements that provide an indication of a local change in concentration of CO2 or other fluid. Targeted measurements may be performed using any desired station and at any time. For example, targeted measurements are performed using one or more measurement stations 42 at or near a location or locations corresponding to a boundary of the plume map (or any other location so that changes in the plume and/or any nonconformance can be detected).

FIGS. 3, 8 and 9 illustrate aspects of an example of the use of targeted measurements in conjunction with distributed measurements and plume modeling.

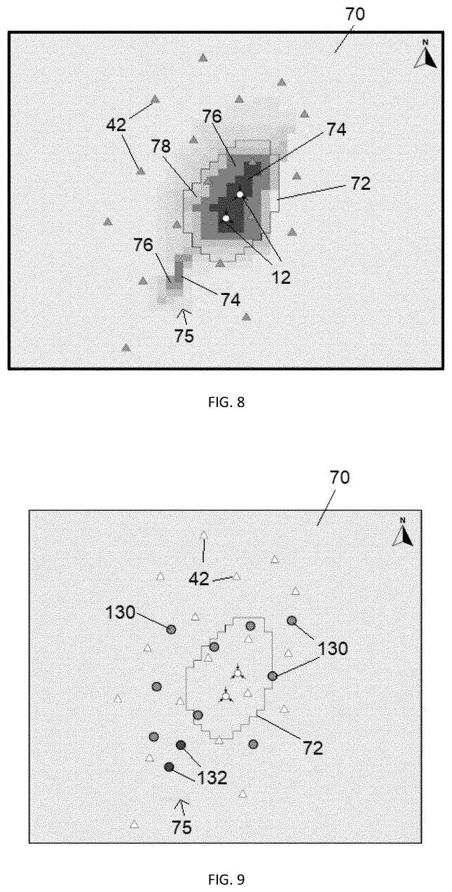

FIG. 3 shows a monitored plume and a plume model generated at a time t. Subsequently, monitoring continues and microseismic data (and/or other relevant measurement data) is collected. As shown in FIG. 8, at a subsequent time t+1, CO2 concentrations have increased in a region 75 outside of the model (i.e., outside of the boundary 72).

FIG. 9 shows the model boundary 72, as well as locations 130 of previously performed targeted measurements. Based on the changes in concentration, additional locations 132 are selected for additional targeted measurements to be performed to confirm the estimated concentration variance in the region 75 outside of the model. The model may be updated after the additional targeted measurements are performed and the current estimations are confirmed.

Referring again to FIG. 7, at block 126, various actions may be performed based on the above measurements. For example, monitoring information can be output to a user or other entity, in the form of graphical representations (e.g., plume maps), textual representations, tables, etc. Other actions include transmission to one or more remote entities for storage and/or analysis. Further actions may include controlling parameters of an operation. For example, a CO2 sequestration operation can be controlled based on monitoring information (e.g., by controlling flow rate, injection pressure, stopping or pausing the operation, etc.).

Set forth below are some embodiments of the foregoing disclosure:

Embodiment 1: A system for monitoring a subterranean region, comprising: a surface assembly including a processor and a communication device; and a plurality of measurement stations distributed about the subterranean region and configured to autonomously measure an evolution of a fluid injected into the subterranean region, each measurement station including a first measurement device configured to measure a first property and a second measurement device configured to measure a second property that is different than the first property; wherein the processor is configured to receive measurement data from each measurement stations, and determine a location and a concentration of at least a portion of the injected fluid.

Embodiment 2: The system as in any prior embodiment, wherein the injected fluid includes carbon dioxide gas injected into an injection region of the subterranean region.

Embodiment 3: The system as in any prior embodiment, wherein each measurement station is configured to wirelessly communicate with the communication device.

Embodiment 4: The system as in any prior embodiment, wherein each measurement station includes a power source.

Embodiment 5: The system as in any prior embodiment, wherein each measurement station includes a seismic sensor configured to passively measure seismic activity, and the processor is configured to generate and/or update a model representing a distribution of the injected fluid based on seismic data received from each measurement station.

Embodiment 6: The system as in any prior embodiment, wherein the processor is configured to select a single measurement station and direct the selected measurement station to perform a localized targeted measurement of fluid concentration.

Embodiment 7: The system as in any prior embodiment, wherein the single measurement station is selected based on the model.

Embodiment 8: The system as in any prior embodiment, wherein the single measurement station is selected based on a change in the distribution of the injected fluid.

Embodiment 9: The system as in any prior embodiment, wherein the first measurement device includes a passive seismic sensor.

Embodiment 10: The system as in any prior embodiment, wherein the second measurement device is selected from at least one of: an atmospheric sensing device, a soil gas monitoring sensor, and a groundwater quality sensor.

Embodiment 11: A method of monitoring a subterranean region, comprising: receiving, by a surface assembly, measurement data from a plurality of remotely located measurement stations distributed about the subterranean region, each measurement station configured to autonomously measure properties of a fluid injected into the subterranean region, each measurement station including a first measurement device configured to measure a first property and a second measurement device configured to measure a second property that is different than the first property; and determining a location and a concentration of at least a portion of the injected fluid based on the measurement data.

Embodiment 12: The method as in any prior embodiment, wherein the injected fluid includes carbon dioxide injected into an injection region of the subterranean region.

Embodiment 13: The method as in any prior embodiment, wherein the measurement data is received from each measurement station via a wireless communication.

Embodiment 14: The method as in any prior embodiment, wherein each measurement station includes a seismic sensor configured to passively measure seismic activity.

Embodiment 15: The method as in any prior embodiment, wherein determining the location and the concentration includes generating and/or updating a model representing a distribution of the injected fluid based on seismic data received from each measurement station.

Embodiment 16: The method as in any prior embodiment, wherein determining the location and the concentration includes selecting a single measurement station and directing the selected measurement station to perform a localized measurement of fluid concentration.

Embodiment 17: The method as in any prior embodiment, wherein the single measurement station is selected based on the model.

Embodiment 18: The method as in any prior embodiment, wherein the single measurement station is selected by selecting a measurement location based on a change in the distribution of the injected fluid.

Embodiment 19: The method as in any prior embodiment, wherein the first measurement device includes a passive seismic sensor, and the second measurement device is selected from at least one of: an atmospheric sensing device, a soil gas monitoring sensor, and a groundwater quality sensor.

Embodiment 20: The method as in any prior embodiment, further comprising controlling a parameter of a subterranean operation based on determining the location and the concentration.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, fluid sampling, testing, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A system for monitoring a subterranean region, comprising:
a surface assembly including a processor and a communication device; and
a plurality of measurement stations distributed about the subterranean region and configured to autonomously measure an evolution of a fluid injected into the subterranean region, each measurement station including a first measurement device configured to measure a first property and a second measurement device configured to measure a second property that is different than the first property;
wherein the processor is configured to receive measurement data from each measurement stations, and determine a location and a concentration of at least a portion of the injected fluid.

2. The system of claim 1, wherein the injected fluid includes carbon dioxide gas injected into an injection region of the subterranean region.

3. The system of claim 1, wherein each measurement station is configured to wirelessly communicate with the communication device.

4. The system of claim 1, wherein each measurement station includes a power source.

5. The system of claim 1, wherein each measurement station includes a seismic sensor configured to passively measure seismic activity, and the processor is configured to generate and/or update a model representing a distribution of the injected fluid based on seismic data received from each measurement station.

6. The system of claim 5, wherein the processor is configured to select a single measurement station and direct the selected measurement station to perform a localized targeted measurement of fluid concentration.

7. The system of claim 6, wherein the single measurement station is selected based on the model.

8. The system of claim 5, wherein the single measurement station is selected based on a change in the distribution of the injected fluid.

9. The system of claim 1, wherein the first measurement device includes a passive seismic sensor.

10. The system of claim 9, wherein the second measurement device is selected from at least one of: an atmospheric sensing device, a soil gas monitoring sensor, and a groundwater quality sensor.

11. A method of monitoring a subterranean region, comprising:
receiving, by a surface assembly, measurement data from a plurality of remotely located measurement stations distributed about the subterranean region, each measurement station configured to autonomously measure properties of a fluid injected into the subterranean region, each measurement station including a first measurement device configured to measure a first property and a second measurement device configured to measure a second property that is different than the first property; and
determining a location and a concentration of at least a portion of the injected fluid based on the measurement data.

12. The method of claim 11, wherein the injected fluid includes carbon dioxide injected into an injection region of the subterranean region.

13. The method of claim 11, wherein the measurement data is received from each measurement station via a wireless communication.

14. The method of claim 11, wherein each measurement station includes a seismic sensor configured to passively measure seismic activity.

15. The method of claim 11, wherein determining the location and the concentration includes generating and/or updating a model representing a distribution of the injected fluid based on seismic data received from each measurement station.

16. The method of claim 15, wherein determining the location and the concentration includes selecting a single measurement station and directing the selected measurement station to perform a localized measurement of fluid concentration.

17. The method of claim 16, wherein the single measurement station is selected based on the model.

18. The method of claim 15, wherein the single measurement station is selected by selecting a measurement location based on a change in the distribution of the injected fluid.

19. The method of claim 11, wherein the first measurement device includes a passive seismic sensor, and the second measurement device is selected from at least one of: an atmospheric sensing device, a soil gas monitoring sensor, and a groundwater quality sensor.

20. The method of claim 11, further comprising controlling a parameter of a subterranean operation based on determining the location and the concentration.
